(19) United States
(12) Patent Application Publication
(10) Pub. No.: US 2009/0115184 A1
(43) Pub. Date: May 7, 2009

(54) FORGERY-PROOF VALUE DOCUMENT AND METHOD FOR ITS EXAMINATION

(75) Inventors: Svetlozar Delianski, Berlin (DE); Thomas Jaeger, Berlin (DE); Georg Kinnemann, Bestensee (DE); Eberhard Rohm, Singen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/265,336

(22) Filed: Nov. 5, 2008

(30) Foreign Application Priority Data
Nov. 5, 2007 (DE) 10 2007 053 050.3
Dec. 6, 2007 (DE) 10 2007 058 680.0

(51) Int. Cl. B42D 15/00; G07D 7/12

(52) U.S. Cl. 283/85; 283/91; 283/93; 356/71

(57) ABSTRACT

A forgery-proof value document, in particular a postage stamp, is examined for its authenticity. The value document contains a two-dimensional area with a security element in the form of a two-dimensional structure. The two-dimensional area is provided with, for example printed with, at least one first and at least one other substance. When illuminated with light that is visible to the human eye, the two substances have the same hue and different hues when illuminated with infrared light. The security element is placed on the value document by use the first substance, the remaining part of the area by use of the at least one other substance. When illuminated with visible light the entire two-dimensional area appears in the same hue. When illuminated with infrared light the security element is optically distinguished from the remaining area.

### CROSS-REFERENCE TO RELATED APPLICATIONS

This application claims the priority, under 35 U.S.C. § 119, of German applications DE 10 2007 053 050.3, filed Nov. 5, 2007, and DE 10 2007 058 680.0, filed Dec. 6, 2007; the prior applications are herewith incorporated by reference in their entireties.

### BACKGROUND OF THE INVENTION

### Field of the Invention

The invention relates to a forgery-proof value document, in particular a postage stamp, and a method for examining a value document.

A value document is known from published, non-prosecuted German patent application DE 103 22 794 A1. There it is proposed to provide the value document with a specified two-dimensional security element. To this end, the security element is applied to the value document by a luminescent substance. To examine the value document, it is illuminated with an optical scanning signal within a wavelength between 940 nm and 990 nm. The reflection caused by the illumination, there referred to as the response signal, is detected. The detected response signal is then examined as to whether or not the security element is present in the image. If the security element is present then the value document is genuine.

It is proposed in non-prosecuted German patent application DE 102004022995 A1 that the security element be incorporated in a geometric identifier. Again, the value document is illuminated and the security element is excited into emission of radiation. Periodically pulsed electromagnetic radiation is used for the illumination.

These two methods and the sensors used for them require that a fluorescent or a phosphorescent substance be employed in the manufacture of the value document. These substances are expensive and their use in the manufacture of the value document can be hazardous to humans and to the environment. Moreover, the examination requires time because, first, the security element of a genuine value document must be easily excited by radiation before the value document produces a reflection that can be evaluated.

A device and a method for examining franking on a postal consignment are described in non-prosecuted German patent application DE 10105273 A1, corresponding to U.S. patent publication No. 20040096081 A1. For this an examination is made to decide whether or not the postal consignment contains certain specified graphical information. The graphical information, for example images of stamps, is specified so that they are stored in a database.

How the use of forged stamps is effectively prevented is not described.

### SUMMARY OF THE INVENTION

It is accordingly an object of the invention to provide a forgery-proof value document and a method for its examination which overcome the above-mentioned disadvantages of the prior art methods and devices of this general type.

With the foregoing and other objects in view there is provided, in accordance with the invention, a value document. The value document has an optically detectable security element having a two-dimensional structure and a two-dimensional area containing the security element and has at least one first substance and at least one second substance. It is possible for the first and second substances to have a same hue when illuminated with visible light being visible to a human eye; and different hues when illuminated with infrared light. The security element is placed on the value document by use of the first substance and a remaining area of the two-dimensional area is placed on the value document by use of the second substance, so that: when illuminated with the visible light an entire area of the two-dimensional area appears in a same hue; and when illuminated with the infrared light the security element is optically distinguished from the remaining area.

The inventive value document contains a two-dimensional area with a security element in the form of a two-dimensional structure. The two-dimensional area is provided with, for example printed with at least one first and at least one other substance.

When illuminated with light that is visible to the human eye, the two substances have the same hue and have different hues when illuminated with infrared light. The security element is attached to the value document by the first substance, the remaining part of the area by the at least one other substance. When illuminated with visible light, the entire two-dimensional area appears in the same hue. When illuminated with infrared light the security element is optically distinguished from the remaining area.

The inventive value document can be printed without fluorescent or phosphorescent substances.

Accordingly, in order to examine a value document as to whether or not it contains the specified security element, the value document is illuminated with infrared light.

In accordance with an added feature of the invention, the security element has a form of a matrix code.

In accordance with another feature of the invention, at least one of the first and second substances in an infrared spectrum causes no reflection from incident infrared light.

In accordance with an additional feature of the invention, the security element has a resolution of at least 300 dpi.

In accordance with a further feature of the invention, a further security element is provided and is visible in visible light and has a resolution of at least 300 dpi.

With the foregoing and other objects in view there is provided, in accordance with the invention, a method for examining a value document. The method includes the steps of: directing a light beam onto the value document that contains infrared light; detecting a reflection of the light beam produced by the value document; carrying out a check as to whether or not the reflection shows an image of a specified security element in a form of a two-dimensional structure; detecting the reflection of the infrared light produced by the value document and checking the reflection against a presence of a security element image; and deciding that the value document is genuine if the reflection contains the image of the specified security element.

In accordance with an added feature of the invention, an electronic library with at least one two-dimensional pattern is specified, and an examination as to whether the image of the specified security element is contained in the reflection of the infrared light includes the step where a check is carried out as to whether the reflection contains a pattern that is identical to at least one pattern in the library.

With the foregoing and other objects in view there is provided, in accordance with the invention, a device for examining a value document. The device includes a light source directing a light beam onto the value document, and the light source is further embodied to direct infrared light onto the value document. An imaging device is provided for detecting a reflection of the light beam produced by the value document. The imaging device detects the reflection of the infrared light produced by the value document. An evaluation unit is provided for checking if the reflection contains an image of a specified security element in a form of a two-dimensional structure. More specifically, the evaluation unit examines the reflection of the infrared light for a presence of the image of the specified security element, and if the reflection contains the image of the specified security element, decides that the value document is genuine,

Other features which are considered as characteristic for the invention are set forth in the appended claims.

Although the invention is illustrated and described herein as embodied in a forgery-proof value document and a method for its examination, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is an illustration of a stamp with a matrix code that is overprinted with an infrared printing ink according to the invention; and

FIG. 2 is a block diagram of a device for examining the value document according to the invention.

### DETAILED DESCRIPTION OF THE INVENTION

In the exemplary embodiment the value document is a stamp (“postage stamp”). Examination is carried out in a sorting system. A postal consignment which is provided with the stamp to be examined in the form of a franking stamp passes through the sorting system.

The examination is carried out with the aim of checking whether the stamp on the postal consignment is genuine or forged. Genuine stamps are those that have been issued by a postal services provider. The postal services provider transports the postal consignment and for this employs the sorting system through which the postal consignment passes. If the postal consignment is provided with a genuine stamp, then the transportation of the postal consignment has been paid for, namely by the purchase of the stamp.

On the other hand it is possible that the postal consignment is provided with a forged stamp, that is to say a two-dimensional reproduction of a stamp. The postal services provider has not received any income for the transportation because he has not sold the reproduction.

In the exemplary embodiment the stamp is provided with a security element in the form of a two-dimensional structure. The two-dimensional structure has the form of a matrix code or a grid pattern (barcode) for example. The security element preferably contains information about the stamp in coded form, for example the nominal value of the stamp and additional stipulations regarding the validity period of the stamp.

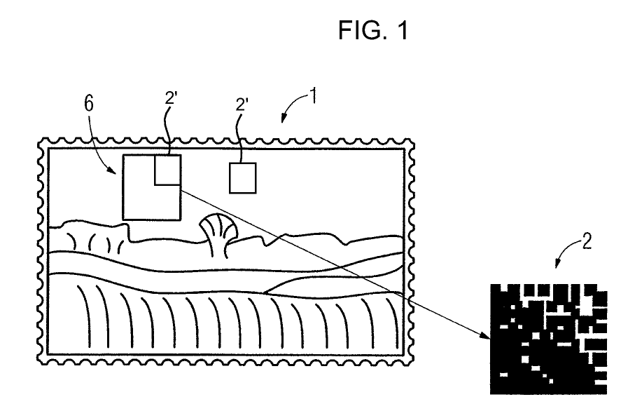

FIG. 1 shows an example of a stamp 1 with a security element 2 in a form of a matrix code 2 that is overprinted with an infrared printing ink. The matrix code is shown greatly enlarged. The security element 2 is printed inside a two-dimensional area 6. The two-dimensional area 6 shows clouds, for example. The matrix code 2 is composed of black and white rectangles.

A reading device of the sorting system generates a digital image of the postal consignment. The image contains an image of the stamp 1 and thus an image of the security element 2 with the coded information. The coded information is evaluated in order to decide for example whether the postal consignment is adequately franked and whether the stamp 1 is currently still valid.

In one embodiment, the two-dimensional security element 2 is additionally used to locate the stamp 1 on the postal consignment and to distinguish it from other pictorial or graphical representations on the postal consignment.

According to the invention, so-called infrared printing inks are used to print the security element 2 onto the stamp 1. Infrared printing inks are defined as printing inks that have a specific emission characteristic in the infrared spectrum. A distinction is made between infrared printing inks that are visible in the infrared spectrum and those that are invisible in the infrared spectrum.

In the exemplary embodiment, the security element 2 is printed on the stamp 1 with a first substance and the surrounding two-dimensional area 6 with at least one other (second) substance. The first substance is preferably visible in the infrared spectrum and the at least one other substance is invisible in the infrared spectrum. Conversely, it is also possible for the first substance to be invisible in the infrared spectrum and the at least one other substance to be visible in the infrared spectrum.

In the exemplary embodiment the substances are printed onto the stamp 1. Other methods can be employed to place a substance on a stamp.

The first substance and the other substance have the same hue in visible light. Visible light is understood to be electromagnetic radiation that has a wavelength from approximately 380 to 780 nanometers (nm) and therefore a frequency from approximately 789 down to 385 THz and is therefore visible to the human naked eye.

Because of the identical hue, the security element 2, which is printed inside the two-dimensional area 6 using the first substance, is not discernible under visible light. In particular, it is not discernible with either the naked eye or with an optical magnifying device. A photocopying device which operates with visible light therefore also makes the security element impossible to copy.

Infrared light is understood to have a longer wavelength than visible light. The wavelength is preferably less than that of macrowaves and lies between 780 nanometers and 1 mm.

If the stamp 1 is illuminated with infrared light, then the stamp reflects infrared light. Because under infrared illumination the first substance has a hue that differs from that of the at least one other substance, the security element 2 is visible in the reflection that the stamp 1 produces when illuminated with infrared light. If the first substance is visible in the infrared range, the security element 2 visibly stands out from the invisible surroundings (the remaining area 6). If the other substance is visible in the infrared region, then the security element 2 can be detected as an invisible two-dimensional structure in the visible surroundings.

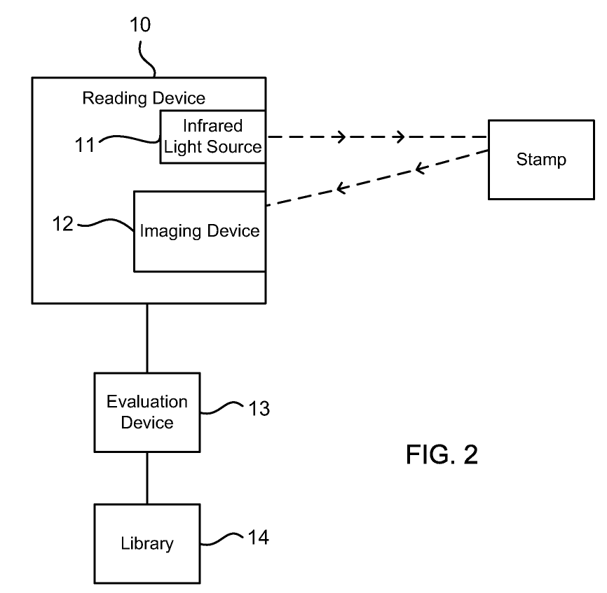

As shown in FIG. 2 the reading device 10 of the sorting system therefore briefly illuminates the postal consignment and the stamp with infrared light from light source 11. The reflection which the postal consignment produces is recorded by an imaging device 12 and delivers a computer-ready infrared image of the postal consignment. The infrared image contains an image of the stamp 3. An evaluation unit 13 searches the infrared image for the security element 2. If the evaluation unit 13 finds the security element 2 in the infrared image, then the stamp 1 is genuine and the postal consignment is further processed. Otherwise, the postal consignment is extracted and manually examined, for example.

Preferably, an electronic library is created with those two-dimensional patterns that are used as security elements. In one embodiment, a plurality of security elements are used in order to distinguish different value ranges of stamps, for example.

The evaluation unit 13 has read access to an electronic library 14. The evaluation unit 13 is supplied with the infrared image of the postal consignment. The evaluation unit 13 checks whether the security element image is contained in the generated reflection of the infrared light. In this connection, the evaluation unit 13 makes a comparison for each pattern in the library 14. The comparison includes the step where the evaluation unit 13 checks that the reflection contains a pattern that is identical to this pattern from the library 14.

Preferably, a reference size is specified for the security element 2 on the stamp 1. The pattern from the library is scaled so that it is exactly the same size as the reference size.

In one embodiment a recognition system is trained with those two-dimensional structures that are printed on the stamps. Those two-dimensional patterns that are used as security elements are stored in the electronic library 14. Additional two-dimensional patterns that are not used as security elements are also stored in the electronic library 14. Furthermore, which two-dimensional structures are valid security elements and which are not, are specified to the evaluation unit 14. By applying a machine-learning process, the recognition system is trained so that it is able to automatically distinguish security elements of other two-dimensional structures.

In one embodiment, the security element 2 is printed with a resolution of at least 300 dpi (dots per inch) in the two-dimensional area 6. This embodiment makes photocopying itself more difficult in cases where the photocopier uses infrared light. So that during copying this two-dimensional structure is identically scanned from the original and is produced on the copy, the structure must be scanned in accordance with the Nyquist-Shannon Theorem with a resolution of at least 2*300=600 dpi. Currently available scanners and photocopiers are not capable of this. A two-dimensional structure with a resolution of at least 300 dpi cannot therefore be copied with a typical modern scanner or photocopier.

In a further embodiment, the stamp has two security elements. As described above, one of the security elements 2 is visible only under infrared light, but not under light in the visible range. As described above, the security element 2 is printed in a two-dimensional area 6. A further security element 2′ is also visible in visible light. However, as just described, it is printed or otherwise placed on the stamp with a resolution of at least 300 dpi. This additional security element 2′ cannot be copied by a typical, modern copier. This embodiment offers further enhanced security.

1. A value document, comprising:
an optically detectable security element having a two-dimensional structure;
a two-dimensional area containing said security element and having at least one first substance and at least one second substance, it being possible for said first and second substances to have:
a same hue when illuminated with visible light being visible to a human eye;
different hues when illuminated with infrared light;
said security element being placed on the value document by means of said first substance and a remaining area of said two-dimensional area being placed on the value document by means of said second substance, so that:
when illuminated with the visible light an entire area of said two-dimensional area appears in a same hue; and
when illuminated with the infrared light said security element is optically distinguished from said remaining area.

2. The value document according to claim 1, wherein said security element has a form of a matrix code.

3. The value document according to claim 1, wherein at least one of said first and second substances in an infrared spectrum causes no reflection from incident infrared light.

4. The value document according to claim 1, wherein said security element has a resolution of at least 300 dpi.

5. The value document according to claim 1, further comprising a further security element being visible in visible light and has a resolution of at least 300 dpi.

6. The value document according to claim 1, wherein the value document is a postage stamp.

7. A method for examining a value document, which comprises the steps of:
directing a light beam onto the value document that contains infrared light;
detecting a reflection of the light beam produced by the value document;
carrying out a check as to whether or not the reflection shows an image of a specified security element in a form of a two-dimensional structure;
detecting the reflection of the infrared light produced by the value document and checking the reflection against a presence of a security element image; and
deciding that the value document is genuine if the reflection contains the image of the specified security element.

8. The method according to claim 7, wherein an electronic library with at least one two-dimensional pattern is specified, and an examination as to whether the image of the specified security element is contained in the reflection of the infrared light includes the step where a check is carried out as to whether the reflection contains a pattern that is identical to at least one pattern in the library.

9. The method according to claim 7, which further comprises providing a postage stamp as the value document.

10. A device for examining a value document, the device containing:
a light source directing a light beam onto the value document, the light source further embodied to direct infrared light onto the value document;
an imaging device for detecting a reflection of the light beam produced by the value document, said imaging device detecting the reflection of the infrared light produced by the value document; and
an evaluation unit for checking if the reflection contains an image of a specified security element in a form of a two-dimensional structure, said evaluation unit examining the reflection of the infrared fight for a presence of the image of the specified security element, and if the reflection contains the image of the specified security element, deciding that the value document is genuine,

11. The device according to claim 10, wherein said evaluation unit has read access to an electronic library having at least one two-dimensional patterns, and is embodied to check during an examination of the reflection whether the reflection contains a pattern that is identical to at least one pattern in the electronic library.

12. The device according to claim 10, wherein the value document is a postage stamp.
